(19) United States
(12) Patent Application Publication
(10) Pub. No.: US 2020/0064644 A1
(43) Pub. Date: Feb. 27, 2020

(54) PARALLAX BARRIER APPARATUS AND NAKED EYE 3D DISPLAY DEVICE USING THE SAME

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: HAI-SHENG WU, Shenzhen (CN); LIN-YUAN TANG, Shenzhen (CN)

(21) Appl. No.: 16/170,528

(22) Filed: Oct. 25, 2018

(30) Foreign Application Priority Data
Aug. 22, 2018 (CN) 201810962904.0

(51) Int. Cl. G02B 27/22; G02B 27/26; G02B 1/14

(52) U.S. Cl. CPC G02B 27/2214; G02B 1/14; G02B 27/26

(57) ABSTRACT

A naked eye 3D display device includes many parallax simulating apparatuses arranged in a straight line. Each apparatus includes a first image generating unit, a second image generating unit arranged side-by-side with the first image generating unit, and a light source facing toward the first image generating unit. First and second images are contrarily polarized and projected to the first image generating unit and to a second image generating unit respectively. A cylindrical barrier film faces toward the first image generating unit and the second image generating unit. Viewed from a first area, the first image is seen through the barrier film but the barrier film blocks the second image. Viewed from a second area, the second image is seen through the barrier film but the barrier film blocks the first image.

### FIELD

The subject matter herein generally relates to displays.

### BACKGROUND

3D display technology is trending because it can reproduce a display in a style that is familiar and cognitive to human. Naked-eye 3D technology is popular because no complicated auxiliary equipment is required. There are a variety of devices, such as a lens-based naked-eye stereoscopic display device, capable of achieving naked-eye 3D display. However, these devices are usually very limiting in view angle and distance.

Therefore, there is room for improvement in the art.

### BRIEF DESCRIPTION OF THE DRAWINGS

Embodiments of the present disclosure will now be described, with references to the attached figures.

FIG. 1 is an isometric view of a first embodiment of a parallax barrier apparatus.

FIG. 2 is an isometric view of a barrier film of the parallax barrier apparatus of FIG. 1, the barrier film being flat.

FIG. 3 is an isometric view of a first polarizing film of the parallax barrier apparatus of FIG. 1.

FIG. 4 is an isometric view of a second polarizing film of the parallax barrier apparatus of FIG. 1.

FIG. 5 is an isometric view of the barrier film of the parallax barrier apparatus of FIG. 1, the barrier film being curved.

FIG. 6A is a sectional view of another embodiment of the barrier film, the barrier film being curved.

FIG. 6B is a sectional view of another embodiment of the barrier film, the barrier film being curved.

FIG. 7 is a schematic view of a working mechanism of the parallax barrier apparatus of FIG. 1, wherein the parallax barrier apparatus is observed from a first view angle.

FIG. 8 is a schematic view of the working mechanism of the parallax barrier apparatus of FIG. 1, wherein the parallax barrier apparatus is observed from a second view angle.

FIG. 9 is a schematic view of the working mechanism of the parallax barrier apparatus of FIG. 8.

FIG. 10 is an isometric view of an embodiment of a naked eye 3D display device.

FIG. 11 is a front view of the naked eye 3D display device of FIG. 10.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series, and the like.

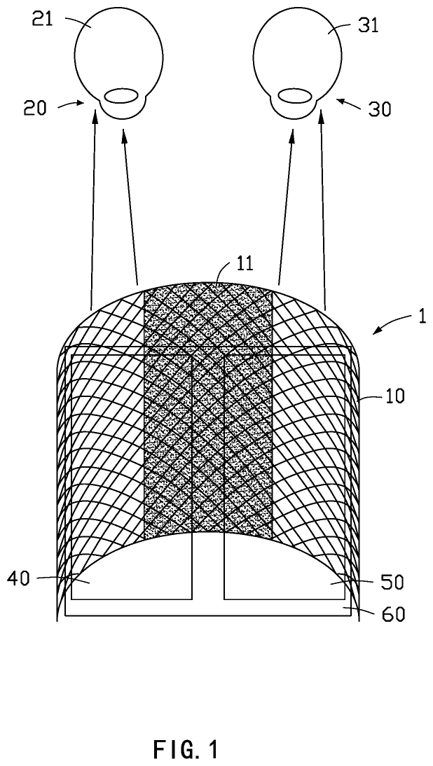

FIG. 1 illustrates a parallax barrier apparatus 1.

The parallax barrier apparatus 1 includes a first image generating unit 40, a second image generating unit 50, a light source 60, and a barrier film 10.

The first image generating unit 40 and the second image generating unit 50 can be display panels, such as LCD panels, for displaying images.

The second image generating unit 50 is arranged side-by-side with the first image generating unit 40.

The light source 60 faces toward the first image generating unit 40 to project a first image and faces toward the second image generating unit 50 to project a second image.

The barrier film 10 includes a cylindrical surface concaved toward the first image generating unit 40 and the second image generating unit 50.

The barrier film 10 and the light source 60 are at opposite sides of the first image generating unit 40 and the second image generating unit 50.

When the parallax barrier apparatus 1 is observed from a first area which is pre-determined, the lighting source 60 projects the first image through the barrier film 10 and the barrier film 10 blocks the second image.

When the parallax barrier apparatus 1 is observed from a second area which is predetermined, the lighting source 60 projects the second image through the barrier film 10 and the barrier film 10 blocks the first image.

In one embodiment, the pre-determined first area can be an area where a right eye 21 of an observer is located, and the pre-determined second area can be an area where a left eye 31 of the observer is located. When the observer observes the parallax barrier apparatus 1, the first image can be seen by the right eye 21 only, and the second image can be seen by the left eye 31 only, so the right eye 21 and the left eye 31 of the observer can see different images simultaneously. A naked eye type 3D display effect is thus obtained.

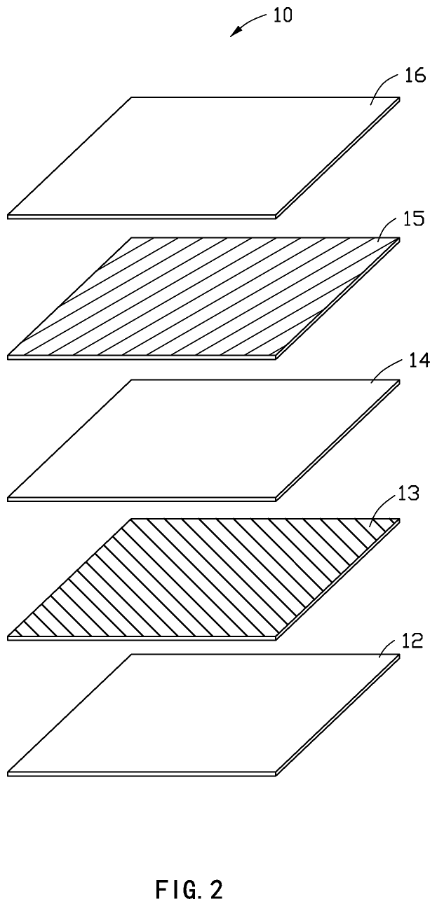

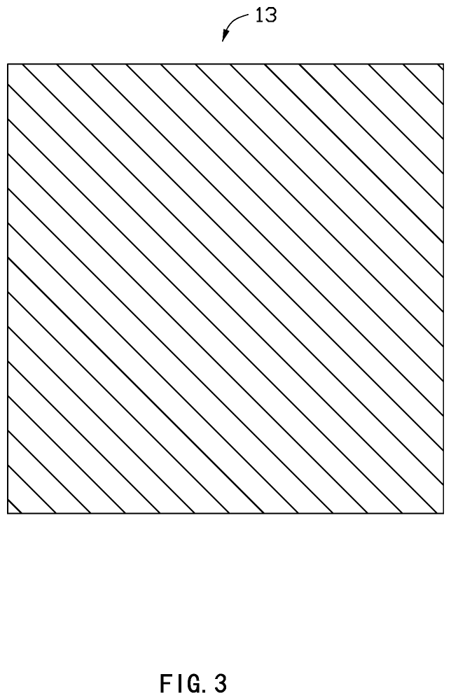

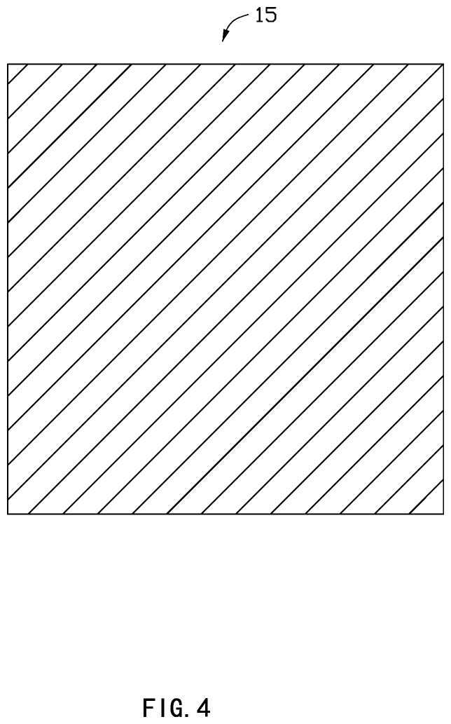

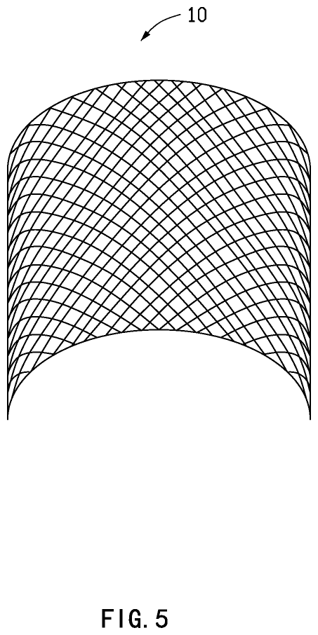

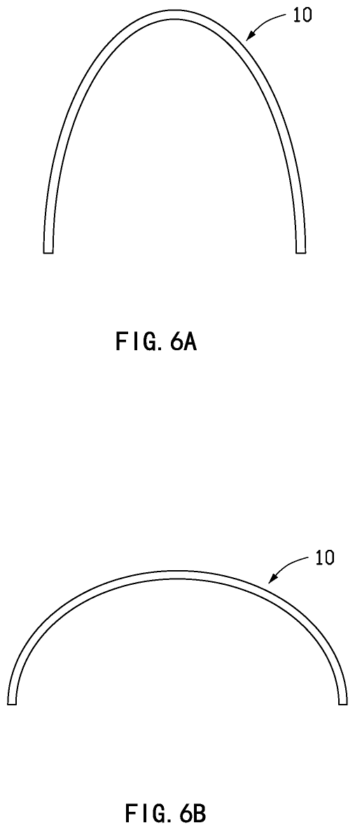

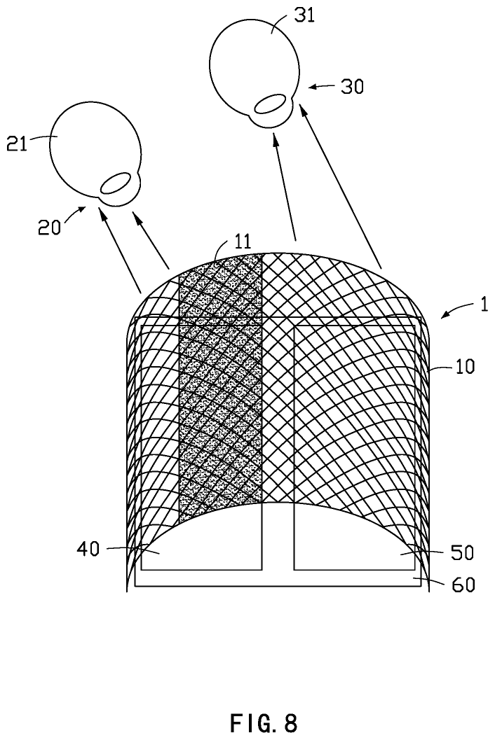

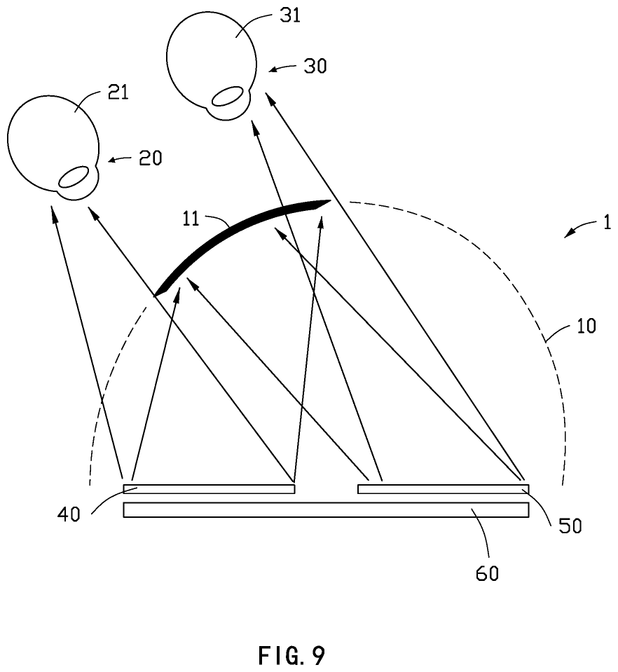

Referring also to FIGS. 2-9, the barrier film 10 includes a first polarizing film 13, a wave plate film 14, and a second polarizing film 15.

The first polarizing film 13, the wave plate film 14, and the second polarizing film 15 are sequentially arranged along a direction away from the first image generating unit 40 and the second image generating unit 50. A polarization direction of the first polarizing film 13 is perpendicular to a polarization direction of the second polarizing film 15.

The light source 60 is a polarized area light source having a polarization direction non-orthogonal with the polarization direction of the first polarizing film 13, or the light source 60 is a non-polarized area light source.

The first polarizing film 13 and the second polarizing film 15 polarize the light emitted by the lighting source 60. Light from the lighting source 60 is polarized when passed through the first polarizing film 13, and since the polarization direction of the first polarizing film 13 is perpendicular to the polarization direction of the second polarizing film 15, the second polarizing film 15 blocks light polarized by the first polarizing film 13.

The wave plate film 14 can be a ½ wave plate film, or the wave plate film 14 can include two ¼ wave plate films.

The barrier film 10 can further include a supporting film 12 which is transparent. The supporting film 12 is attached to a surface of the first polarizing film 13 adjacent to the first image generating unit 40 and the second image generating unit 50, The supporting film 12 supports the first polarizing film 13, the wave plate film 14, and the second polarizing film 15.

The barrier film 10 can further include a protecting film 16 which is transparent. The protecting film 16 is attached to a surface of the second polarizing film 15 away from the first image generating unit 40 and the second image generating unit 50. The protecting film 16 protects the first polarizing film 13, the wave plate film 14, and the second polarizing film 15.

The first polarizing film 13, the wave plate film 14, the second polarizing film 15, and the protecting film 16 can be sequentially laminated on the supporting film 12.

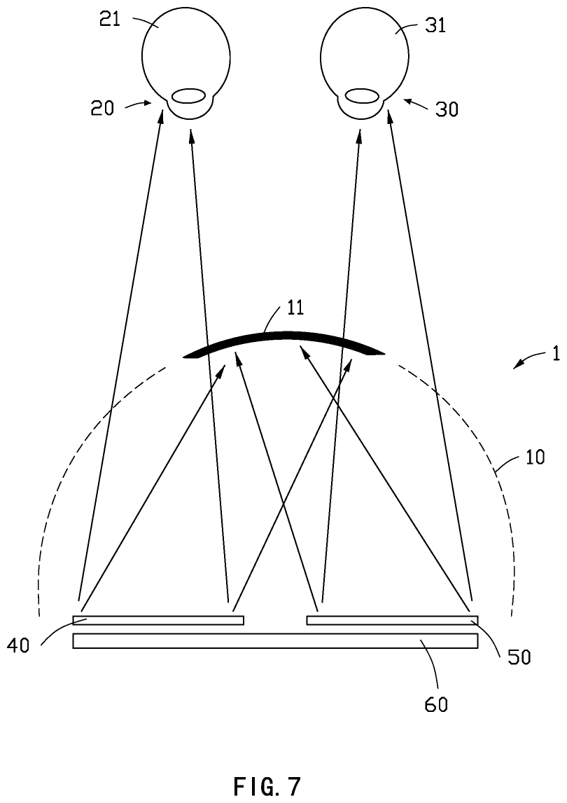

Referring to FIG. 7, in at least one embodiment, the barrier film 10 is arc-shaped and includes a blocking area 11.

When the parallax barrier apparatus 1 is observed from the first area, light projected to the second image generating unit 50 is blocked by the blocking area 11, and the barrier film 10 blocks the second image. Light projected to the first image generating unit 40 is not within the blocking area 11 and is not blocked by the blocking area 11, therefore only the first image can be seen in the first area.

When the parallax barrier apparatus 1 is observed from the second area, light projected to the first image generating unit 40 is blocked by the blocking area 11, and the barrier film 10 blocks the first image. Light projected to the second image generating unit 50 is not within the blocking area 11 and is not blocked by the blocking area 11, therefore only the second image can be seen in the second area.

In at least one embodiment, the barrier film 10 is an arc-shaped ellipse.

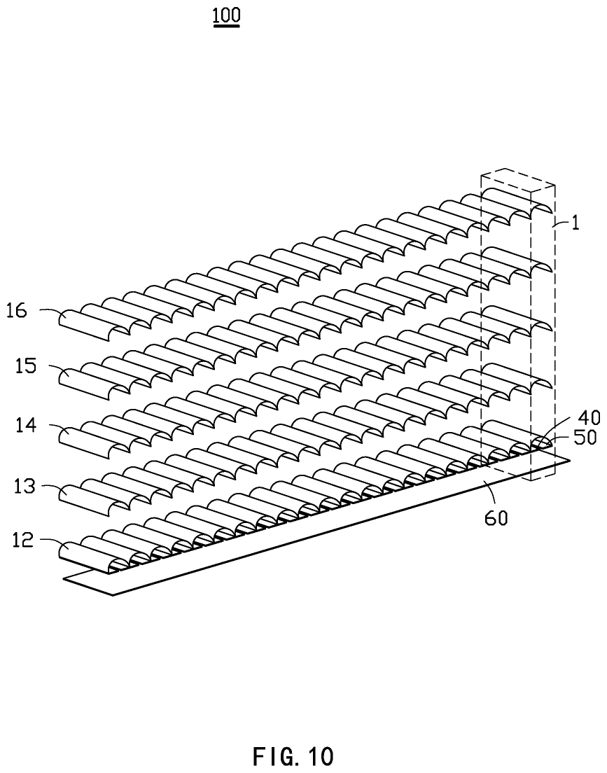

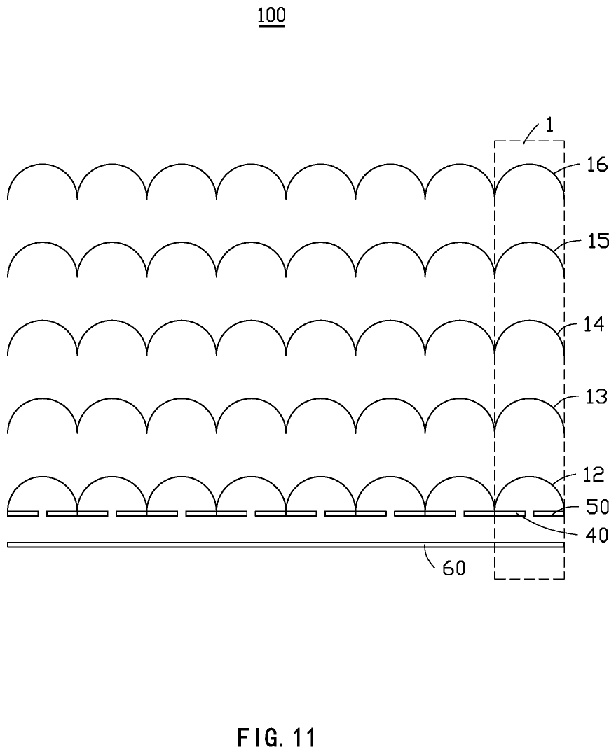

Referring to FIGS. 10-11, a naked eye 3D display device 100 is described as follows.

The naked eye 3D display device 100 includes a number of parallax barrier apparatuses 1 arranged in a straight line. Each of the parallax barrier apparatuses 1 can be any one of the parallax barrier apparatus 1 as described above.

The embodiments shown and described above are only examples. Even though numerous characteristics and advantages of the present technology have been set forth in the foregoing description, together with details of the structure and function of the present disclosure, the disclosure is illustrative only, and changes may be made in the details, including matters of shape, size, and arrangement of the parts within the principles of the present disclosure, up to and including the full extent established by the broad general meaning of the terms used in the claims.

What is claimed is:

1. A parallax barrier apparatus, comprising:
a first image generating unit;
a second image generating unit arranged side-by-side with the first image generating unit;
a light source facing toward the first image generating unit to project a first image and facing toward the second image generating unit to project a second image; and
a barrier film comprising a cylindrical surface concaved toward the first image generating unit and the second image generating unit;
when the parallax barrier apparatus is observed from a first area, the lighting source projects the first image through the barrier film and the barrier film blocks the second image; and when the parallax barrier apparatus is observed from a second area, the lighting source projects the second image through the barrier film and the barrier film blocks the first image.

2. The parallax barrier apparatus of claim 1, wherein the barrier film comprises:
a first polarizing film;
a wave plate film; and
a second polarizing film;
wherein the first polarizing film, the wave plate film and the second polarizing film are sequentially arranged along a direction away from the first image generating unit and the second image generating unit; a polarization direction of the first polarizing film is perpendicular to a polarization direction of the second polarizing film.

3. The parallax barrier apparatus of claim 2, wherein the barrier film comprises a supporting film attached to a surface of the first polarizing film adjacent to the first image generating unit and the second image generating unit.

4. The parallax barrier apparatus of claim 3, wherein the barrier film further comprises a protecting film attached to a surface of the second polarizing film away from the first image generating unit and the second image generating unit.

5. The parallax barrier apparatus of claim 4, wherein the first polarizing film, the wave plate film, the second polarizing film and the protecting film are sequentially laminated on the supporting film.

6. The parallax barrier apparatus of claim 2, wherein the barrier film is arc-shaped and comprises a blocking area;
when the parallax barrier apparatus is observed from the first area, light emitted by the lighting source and projected to the second image generating unit is blocked by the blocking area, and the barrier film blocks the second image; and when the parallax barrier apparatus is observed from the second area, light emitted by the lighting source and projected to the first image generating unit is blocked by the blocking area, and the barrier film blocks the first image.

7. The parallax barrier apparatus of claim 6, wherein the barrier film is elliptical arc-shaped and comprises a blocking area;
when the parallax barrier apparatus is observed from a first area, light emitted by the lighting source and projected to the second image generating unit is blocked by the blocking area, and the barrier film blocks the second image; and when the parallax barrier apparatus is observed from a second area, light emitted by the lighting source and projected to the first image generating unit is blocked by the blocking area, and the barrier film blocks the second image.

8. The parallax barrier apparatus of claim 7, wherein the barrier film and the light source are at two opposite sides of the first image generating unit and the second image generating unit.

9. The cable connector assembly of claim 8, wherein the light source is a polarized area light source having a polarization direction non-orthogonal with the polarization direction of the first polarizing film, or the light source is a non-polarized area light source.

10. The parallax barrier apparatus of claim 6, wherein the wave plate film is a ½ wave plate film, or the wave plate film comprises two ¼ wave plate films.

11. A naked eye 3D display device comprising a plurality of parallax barrier apparatuses arranged in a straight line, each of the plurality of parallax barrier apparatuses comprises:
a first image generating unit;
a second image generating unit arranged side-by-side with the first image generating unit;
a light source facing toward the first image generating unit to project a first image and facing toward the second image generating unit to project a second image; and
a barrier film comprising a cylindrical surface facing toward the first image generating unit and the second image generating unit;
when the parallax barrier apparatus is observed from a first area, the lighting source projects the first image through the barrier film and the barrier film blocks the second image; and when the parallax barrier apparatus is observed from a second area, the lighting source projects the second image through the barrier film and the barrier film blocks the first image.

12. The naked eye 3D display device of claim 11, wherein the barrier film comprises:
a first polarizing film;
a wave plate film; and
a second polarizing film;
wherein the first polarizing film, the wave plate film and the second polarizing film are sequentially arranged along a direction away from the first image generating unit and the second image generating unit; a polarization direction of the first polarizing film is perpendicular to a polarization direction of the second polarizing film.

13. The naked eye 3D display device of claim 12, wherein the barrier film comprises a transparent supporting film attached to a surface of the first polarizing film adjacent to the first image generating unit and the second image generating unit.

14. The naked eye 3D display device of claim 13, wherein the barrier film further comprises a transparent protecting film attached to a surface of the second polarizing film away from the first image generating unit and the second image generating unit.

15. The naked eye 3D display device of claim 13, wherein the first polarizing film, the wave plate film, the second polarizing film and the protecting film are sequentially laminated on the supporting film.

16. The naked eye 3D display device of claim 12, wherein the barrier film is arc-shaped and comprises a blocking area;
when the parallax barrier apparatus is observed from the first area, light emitted by the lighting source and projects to the second image generating unit is blocked by the blocking area, and the barrier film blocks the second image; and when the parallax barrier apparatus is observed from the second area, light emitted by the lighting source and projects to the first image generating unit is blocked by the blocking area, and the barrier film blocks the first image.

17. The naked eye 3D display device of claim 16, wherein the barrier film is elliptical arc-shaped and comprises a blocking area;
when the parallax barrier apparatus is observed from a first area, light emitted by the lighting source and projects to the second image generating unit is blocked by the blocking area, and the barrier film blocks the second image; and when the parallax barrier apparatus is observed from a second area, light emitted by the lighting source and projects to the first image generating unit is blocked by the blocking area, and the barrier film blocks the second image.

18. The naked eye 3D display device of claim 17, wherein the barrier film and the light source are located at two opposite sides of the first image generating unit and the second image generating unit.

19. The naked eye 3D display device of claim 18, wherein the light source is a polarized area light source having a polarization direction non-orthogonal with the polarization direction of the first polarizing film, or the light source is a non-polarized area light source.

20. The naked eye 3D display device of claim 16, wherein the wave plate film is a ½ wave plate film, or the wave plate film comprises two ¼ wave plate films.
